(19) United States
(12) Patent Application Publication
(10) Pub. No.: US 2021/0303195 A1
(43) Pub. Date: Sep. 30, 2021

(54) ENABLING ERASURE OF SENSITIVE INFORMATION IN A BLOCKCHAIN

(71) Applicant: Algorand Inc., Boston, MA (US)

(72) Inventor: Silvio Micali, Brookline, MA (US)

(21) Appl. No.: 17/213,410

(22) Filed: Mar. 26, 2021

Related U.S. Application Data
(60) Provisional application No. 63/000,417, filed on Mar. 26, 2020.

(51) Int. Cl. G06F 3/06

(52) U.S. Cl. CPC G06F 3/0652; G06F 3/0679; G06F 3/0604

(57) ABSTRACT

Techniques for enabling one or more entities of a blockchain system to carry out operations using a blockchain of the blockchain system. For example, an erasable portion of a transaction can be erased while preserving a non-erasable portion of the transaction. The block containing the transaction, including the non-erasable portion, remains a valid block of the blockchain.

### CLAIM OF PRIORITY

This application claims priority to U.S. Patent Application Ser. No. 63/000,417, filed on Mar. 26, 2020, the entire contents of which are hereby incorporated by reference.

### TECHNICAL FIELD

This description relates generally to erasure of information in a blockchain.

### BACKGROUND

Blockchain-based systems typically use techniques to prevent the modification of any information stored in a block. This feature of blockchain-based systems is sometimes in conflict with, e.g., regulatory schemes that require the erasure of sensitive information.

### SUMMARY

The implementations described here relate to methods, systems, apparatuses, and techniques for erasure of information in a blockchain. For example, an erasable portion of a transaction can be erased while preserving a non-erasable portion of the transaction. The block containing the transaction, including the non-erasable portion, remains a valid block of the blockchain.

### BRIEF DESCRIPTION OF THE DRAWINGS

FIG. 1 shows an example blockchain.

FIGS. 2A and 2B show entities that interact with a blockchain.

FIGS. 3 and 4 show flowcharts of processes for enabling one or more entities of a blockchain system to carry out operations using a blockchain of the blockchain system.

FIG. 5 illustrates an example computer system.

### DETAILED DESCRIPTION

A blockchain-based system can be configured to allow some information to be removed from existing blocks in order to comply with “Right To Be Forgotten” (RTBF) regulations or otherwise remove sensitive or personal information. For example, the blockchain-based system can enable the designation of some information as erasable such that once the information is removed from a particular block, the integrity of the block is maintained and the information cannot be later derived or guessed from the remaining information in the block.

Many governments have instituted data privacy laws. For example, Article 17 of the European Union's General Data Protection Regulation establishes the right to erasure of personal data (“right to be forgotten”, also referred to as “RTBF”). Data privacy laws and different forms of the RTBF are not unique to the European Union. Other legal systems, such as Brazil, Australia, or Canada have similar or stricter rules. This description uses the European Union's RTBF as a primary example, but the technology described here can be used to comply with other types of data privacy laws, other types of data privacy concerns outside of legal regimes, etc.

The RTBF applies to personal data only: name, birthdate, government identifier, residential address, employer, education, bank account #, credit card #, blood type, gender, sexual orientation, marital status, language, disability, religion, etc. More generally, it may apply to any piece of data which, when considered alone or in combination with other data in the possession of a data collector, can identify the data subject.

This said, the RTBF does not give the data subject an absolute right to erase her data whenever she wants. For example, when applying for a mortgage, the borrower may consensually give the lender all kinds of relevant personal information to keep at least for the duration of the loan, in which case the borrower has no RTBF. More generally, the RTBF does not apply to non-personal data. It does not guarantee privacy, for instance, about the price paid to purchase a given piece of real estate. Such information may be protected contractually, but not under the RTBF or other data privacy laws.

In strict data privacy jurisdictions, the basic rule on the storage of personal data requires that such data should be (1) stored or processed with the specific consent of the data subject and (2) tagged and clearly associated with such consent. The technology described here generally applies to data that, after having been made available (for whatever reason), should be erased (no matter how, why, and by whom this erasure is requested). In particular, these techniques can be applied to RTBF compliance for decentralized, permissionless blockchains in general, and for the Algorand blockchain in particular.

The RTBF and the Blockchain

The concept of an RTBF-compliant blockchain may appear counterintuitive. Blockchains often prioritize transparency and immutability, while the RTBF is about erasing personal information that was previously public, if the proper conditions are satisfied.

This conceptual difficulty may be exacerbated when the blockchain is decentralized and permissionless. Such blockchains are different from, e.g., the Internet and search engines. For example, an Internet search engine provider typically controls multiple servers all other the world and maintains its own centralized database. Millions of users may request specific pages of this database, but the users do not participate in its maintenance and growth. It is thus easy for a search engine to handle an RTBF request to de-link a given page. If the request is legitimate, then it will de-link that page. And if it continues to make it accessible, the individual who had the right to demand its removal may take legal action.

By contrast, a distributed blockchain is typically maintained by a large number (e.g., thousands or more) of users all over the world. In these instances, it may not be clear whether a specific entity is responsible for properly deleting personal information. Further, in a typical blockchain, all information is cryptographically bound together, so that one cannot remove any information, personal or not, without invalidating the entire blockchain. Thus, removing information is not a trivial task, absent a specific mechanism to do so.

Accordingly, the techniques presented here can be used for a blockchain that complies with current RTBF regulations as well as potential future data privacy regulations. While some other techniques may authorize trusted entities to carry out data erasure, those techniques may not be ideal for a blockchain system. For example, while a few trusted entities could re-write the blockchain and expunge any personal data that should be forgotten, those entities also pose a security risk because they could also re-write history, in any way they want, the moment they no longer remain trustworthy.

In contrast, true decentralization is a great source of security. Transparency can be a major source of trust. Accordingly, the techniques described here can deliver a truly decentralized and transparent blockchain capable of implementing RTBF regulations.

Two Types of Transactions

A blockchain can safely store all kinds of transactions. Two examples are as follows:

Data transactions: Such a transaction T on a blockchain makes some specific data, D, available to everyone and trusted to be inalterable. A data transaction T may also include some personal information, I. If so, we write T=(D, I).

Payments: In a blockchain, a payment P includes the payer's public key, the payee's public key, the amount of money transferred from the first key to the second, and the payer's digital signature authorizing the transaction. We refer to all this information as the monetary transfer proper, M. But a payment P may include other information. In particular, some personal information, I. If so, we write P=(M, I).

These two types of transactions may overlap. (For instance, a payment P may also include some separate data D that is not personal information, nor a monetary transfer, that should be posted permanently on the blockchain: P=(M, I, D).) However, in this description, for the purpose of clarity, we assume they do not overlap. Further, payments are just a special type of transfers of general assets, and whatever we say about payments (and balances) apply to these general transfers as well.

To be sure, monetary transfers are hardly personal information and are not directly affected by the RTBF. However, the RTBF affects a payment P=(M, I), if the personal information I needs to be forgotten. For instance, in a blockchain loan, the borrower may be obliged to make a series of monthly payments to the lender, and in each of those she may want (or be obliged) to include information that identifies her. Thus, in some jurisdictions, she may have the right to have this personal information erased after her loan has been paid off.

Similarly, the RTBF may not apply to a specific piece of data D, but may affect a data transaction T=(D, I). In this way, handling RTBF requests so as to preserve basic blockchain functionalities is harder for data transactions than for payments.

Legacy blockchains, such as Bitcoin, are based on an unspent-transaction-output model and typically require complete knowledge of all the past blocks to validate new payments and blocks. For example, let PK be a public key (of, say, the Bitcoin protocol) that receives an amount of money m (from another public key) in a payment P of a block B. If, in a subsequent payment P* of a later block B*, PK transfers all or part of m (to yet another public key), then P* includes a pointer p to the original payment P. To validate such a new payment P*, one should (1) ‘follow’ the pointer p to look up the payment P in block B, (2) verify that PK did indeed receive an amount of money m, and (3) inspect all blocks between B and B* so as to verify that PK did not already spend m.

Having to consult past transactions in order to participate in the consensus protocol (i.e., in order to validate new transactions and generate new blocks) makes it technically challenging for legacy blockchains to satisfy RTBF requests about personal information included in payments.

To further explain, let P=(M, I) be one such payment and let it be cryptographically secured in a past block B. If, in response to an RTBF request, the personal information I were erased, then P would immediately cease to be cryptographically validated within B and so would the monetary transfer M. In a sense, no one could prove that M really happened. So, the specific amount of money, m, that M transfers to the payee would ‘vaporize.’ If the payee had not already spent it when the information I got erased, she would no longer be able to spend it. Should she try to do so after the erasure of I, she would need to provide a pointer to P. But anyone following such a pointer would find no proof that she ever received the amount of money m.

Let us now consider the case of a data transaction T=(D, I). First of all, note that, though T itself is not a payment, a money-vaporizing problem similar to that described above continues to arise if T contains a ‘posting fee.’ Indeed, such a fee is a form of money transfer (e.g., to the miner who included T in a new block that he successfully appended to the chain). Therefore, within a legacy blockchain, fulfilling an RTBF request about T would cause the retroactive erasure of money transfers, both explicit and implicit, which is not a desirable outcome.

Continuing an example, assume that T=(D, I) does not include any transaction fee and that it is cryptographically secured within a block B. That is, D and I are cryptographically secured in B together rather than individually. Thus, similarly to the payment case discussed above, D also vaporizes the moment I gets erased in response to an RTBF request. Once again, this is not a desirable outcome. Presumably, in fact, the information D was posted on the blockchain to ensure its continual availability and to enable subsequent transactions to rely on it. Indeed, as for the case of payments, posted data affects subsequently posted data.

Balance-Based Blockchains

A newer class of blockchains, which includes Ethereum and Algorand, handles payments differently from legacy blockchains. In these newer blockchains, in order to validate new payments, the participants in the consensus protocol are not required to look up and validate past payments. Rather, they need only keep and update a small amount of information: namely, the current balance of each key in the system. (At every block, the balance of a given key comprises not only the amount of the native currency available to it, but also the stable coins and all other fungible and non-fungible assets that the key owns.) A blockchain that so operates is a balance-based blockchain (BBB).

Different BBBs can have different consensus protocols. For instance, that of Ethereum is currently based on proof of work, while that of Algorand is based on pure proof of stake. But whatever their consensus protocol, Algorand, Ethereum, and all other BBBs can validate new payments and be RTBF-compliant.

In any BBB, let B be the latest block, u a participant in the consensus protocol, and PK a public key. Then, by definition, u knows the current balance of PK, bal_{PK}. That is, she knows that the amount of money available to PK is bal_{PK}, after all payments in the chain, up to and including those in block B, have been executed. (In other BBBs, u may know bal_{PK} by continually monitoring the chain form the start, or by receiving bal_{PK} form a source she trusts. In Algorand, u has a provable way to learn the correct value of bal_{PK} at any block.)

Assume now that an RTBF request is issued to erase the personal information I of a payment P=(M, I) in a prior block A. Then u herself can go ahead and delete I from any copy of the BBB she may have. Such erasure may prevent her (or anyone else who does the same) from proving to others that the monetary transfer M really occurred in block A. Nonetheless, this proving inability does not change the amount of money currently available to PK. This is the case, whether or not PK was the payer or the payee in P. Thus, u knows that, after the personal information I of P has been deleted, the current balance of PK continues to be bal_{PK}.

Accordingly, to check whether all payments made by PK in a newly proposed block C are valid, u need only check that the sum of all amounts of money that PK transfers via its payments in C does not exceed bal_{PK}. If C is added to the chain, then u updates the balance available to PK and that of any other public key making or receiving payments in C. The same is true for the current balance of any public key in the system.

BBBs can successfully comply with RTBF requests about payments for the following simple reasons: (a) balances capture the essential information necessary to process future payments, (b) balances do not contain personal information and are unaffected by RTBF requests, and thus (c) balances could be correctly kept even if RTBF requests demanded the erasure of all past payments.

BBBs, however, cannot successfully comply with RTBF requests about data transactions, because data transactions can be interdependent too and because there is nothing equivalent to a balance for general data. That is, it can be challenging to distill in a compact piece of information what is essential in an entire sequence of general data transactions. Thus, if the personal information I in a data transaction T=(D, I) were to be erased in response to an RTBF request, the data D would automatically cease to be authenticated, with potential consequences for future data transactions that should have depended on D.

A decentralized blockchain typically works due to the efforts of two categories of users:

The consensus participants, who validate new transactions and generate new blocks, and

The information service providers, who enable ordinary users to access information stored in already generated blocks.

(Ordinary users may just transact, store themselves already generated blocks, if they so want, or query information service providers about data stored in the chain, when they need them.)

Systems like Algorand enable consensus participants and information service providers to comply with the RTBF without any drawbacks, for themselves, the blockchain, or the ecosystem at large. Algorand separates erasable from non-erasable data and guarantees the post-erasure integrity of a block by separately storing (and not erasing) the hash of any erasable data.

Traditional Block Structure

In a chain, the ith block, Bᵢ, has two components: (1) the block's data, BDᵢ, which contains the sequence of block's transactions, T₁, . . . , Tₙ, as well as the signatures of the users who issued them, and (2) the block's header, BHᵢ, which cryptographically secures the block's transactions:

Bᵢ=(BDᵢ,BHᵢ),

In its simplest form, BHᵢ includes:

the hash of the previous block's header;

the hash hⱼ of each transaction Tⱼ, hⱼ=H(Tⱼ); and

additional data (e.g., the block number i, time information, and so on).

In symbols, BHᵢ=(H(BHᵢ₋₁), h₁, . . . , hₙ, AD).

Hashing each transaction T_j individually enables one to verify that T_j has not been altered without relying on or disclosing any other transaction. However, it necessitates that a block's header includes one hash value for each of its transactions. It may be more efficient for a block's header to include a single collective hash: the Merkle hash of all transactions together. This special hash still allows one to verify that each transaction in the block has not been altered without involving any other transaction. For example, this is the manner in which Bitcoin hashes its block transactions.

The cryptographic hash function H essentially guarantees that one cannot even minimally change a quantity Q without also causing a change in the hash value H(Q). Accordingly, given the block header BHᵢ, to check that a transaction Tⱼ belongs to the corresponding block and has not been altered, one hashes Tⱼ so as to produce the result H(Tⱼ) and then checks whether this hash value indeed coincides with the value hⱼ that is part of BHᵢ. In some examples, “chaining” the block headers (e.g., including in a header the hash of the previous header) ensures that no one can undetectably alter any header.

This security is a “double-edged sword” with respect to the RTBF. If Tⱼ has a personal information component, Tⱼ=(Xⱼ, Iⱼ), then the corresponding hash value in BHᵢ is hⱼ=H(Xⱼ, Iⱼ). Assume now that, in response to an RTBF request, Iⱼ should be removed from the blockchain. Then, a consensus participant or an information service provider may comply with the request by erasing Iⱼ and substituting (Xⱼ, Iⱼ) with just Xⱼ. However, after forgetting Iⱼ, one will no longer be able to prove that Xⱼ belongs to the blockchain. Indeed, being Xⱼ different from (Xⱼ, Iⱼ), the hash value H(Xⱼ) will differ from the hash value hⱼ=H(Xⱼ, Iⱼ) that is part of BHᵢ. So, after expunging Iⱼ, it becomes impossible to verify the authenticity of Xⱼ.

Example Blockchain

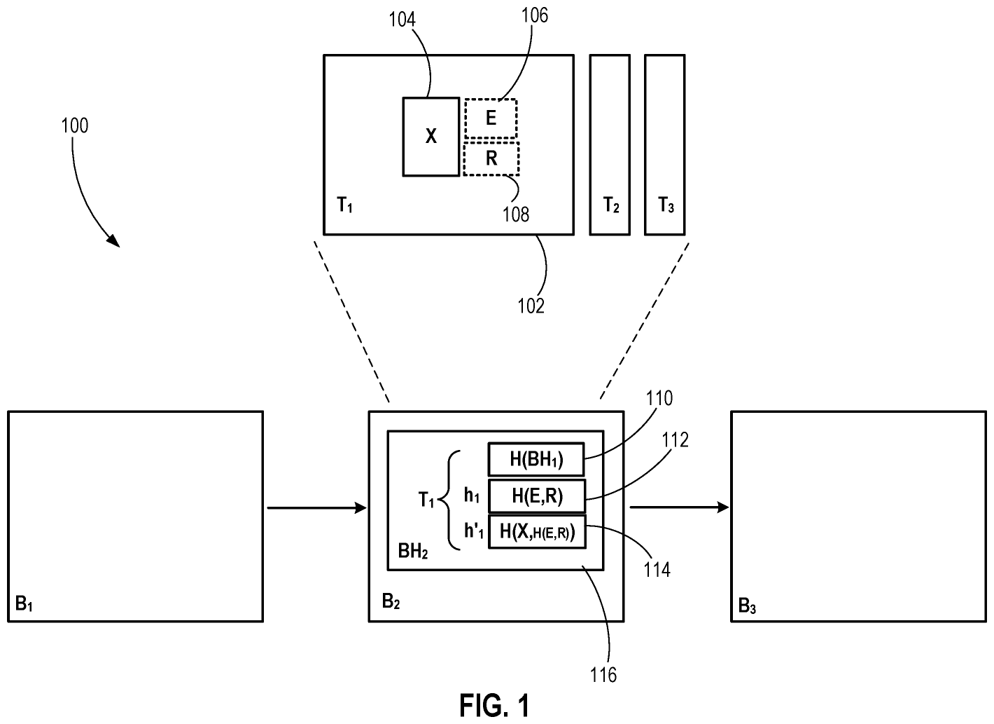

FIG. 1 shows an example blockchain 100 implementing RTBF techniques. For example, the blockchain 100 could be the Algorand blockchain, another blockchain implementing Algorand's protocols, or another kind of blockchain. This blockchain 100 has many blocks, of which three blocks B₁, B₂, B₃ are shown. Each block B₁, B₂, B₃ contains zero or more transactions. For example, one block B₂, is shown containing three transactions T₁, T₂, T₃ (though a typical block may contain many more transactions). Each of these transactions T₁, T₂, T₃ contains an eraseable portion E, a non-erasable (permanent) portion X, and a random value R (sometimes referred to as a “salt”). In some implementations, when a transaction 102 is generated, the transaction 102 contains the non-erasable portion 104, the erasable portion 106, and the random value 108. At a later time, the erasable portion 106 can be erased from the transaction 102 (and thus the block containing the transaction). The transaction 102 remains a valid transaction and the block containing the transaction remains a valid block. In some examples, when the erasable portion 106 is erased (e.g., because the erasable portion 106 contains sensitive or personal information), the random value 108 is also erased.

Each of the blocks B₁, B₂, B₃ contains a header. One block B₂ is shown with an example of a header BH₂ and its corresponding data; the other blocks contain similar headers (not shown). The header BH₂ contains three hashes 110, 112, 114. One is a hash 110 of the header BH₁ (not shown) of the previous block B₁. As described in further detail below, this hash 110 enables continuity of the blockchain 100 even if certain portions of the the previous block B₁ are modified (e.g., an erasable portion of the previous block B₁ is erased). The second is a hash 112 of a combination of the erasable portion of the block B₂ and the random value R. As described below, this hash 112 remains in the block B₂ even if the erasable portion E is erased, thus maintaining a cryptographically secure record of the erasable portion E but not indicating what exactly were the contents of the erasable portion E. The third is a hash 114 of a combination of the permanent portion X of the block B₂ and the hash 112 of the erasable portion E and random number R. As described in more detail below, this third hash 114 can be used to verify that neither the permanent portion P nor the hash 112 representing the erasable portion E have been tampered with. In general, even after an erasable portion 106 is erased, a corresponding header 116 remains unchanged and thus the integrity of the blockchain is preserved.

Example Scenarios

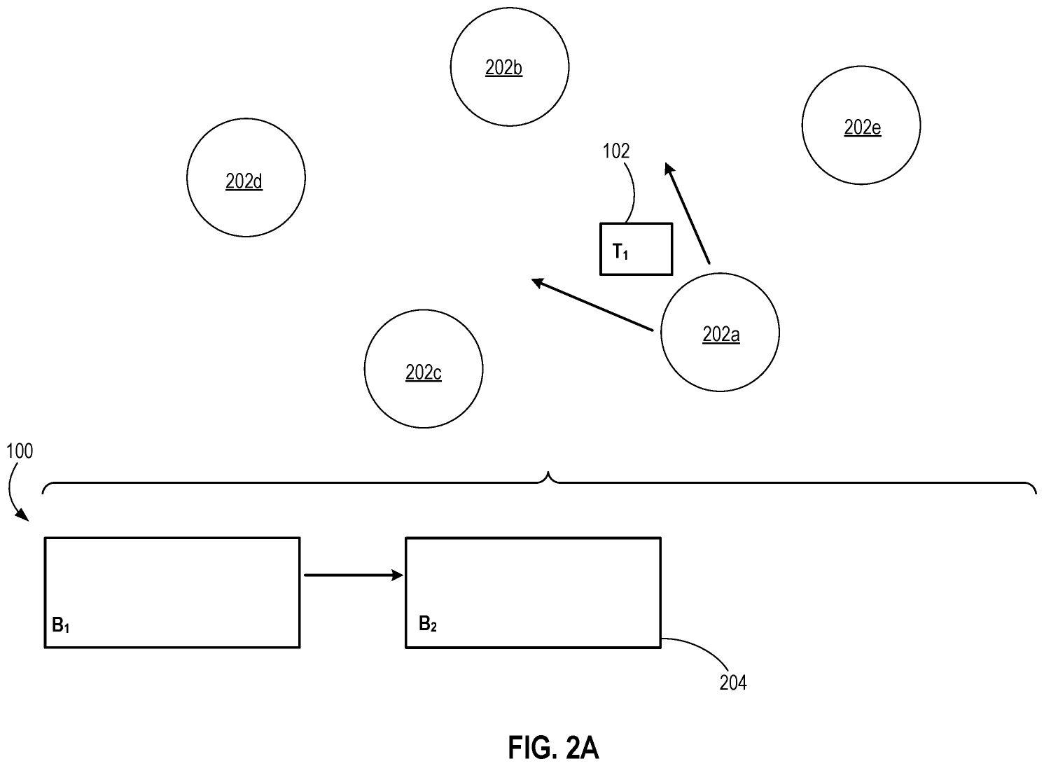

FIGS. 2A and 2B show entities 202a-e that interact with a blockchain 100. In some examples, the entities are nodes of a network that communicate blockchain-related information using one or more common protocols (e.g., protocols compatible with the particular blockchain 100). In the example shown, one of the entities 202a transmits a transaction 102 (e.g., as shown in FIG. 1) to be included in the blockchain 100. The transaction is then validated and incorporated into a block 204 of the blockchain, e.g., by the other entities 202b-e. The process of transmitting a transaction to other entities for the purpose of having the transaction validated by other entities and incorporated into the blockchain is sometimes referred to as “posting” the transaction (e.g., posting the transaction to the blockchain).

At a later time, one of the entities 202a (which may or may not be the same entity as originally posted the transaction) submits a request 206 to have an erasable portion 106 of the transaction 102 removed from the blockchain 100. In some examples, one or more of the other entities 202b-e authenticate the request 206 and remove the erasable portion 106 from the transaction 102 as stored in the block 204. As noted above with respect to FIG. 1, the removal of the erasable portion 106 does not affect the integrity of the blockchain 100. For example, even though the block 204 has been modified, references to the block 204 in later blocks are still valid.

We here distinguish between an entity 202a-e of the blockchain from an issuer of the transaction 102. An entity can be, for example, a node (such as a computer system), a person or organization that controls one or more nodes, etc. In contrast, the issuer of a transaction is distinct from a node or another kind of entity. In some examples, an issuer of a transaction controls a public-private key pair and signed the transaction 102 with the issuer's private key. For example, the request 206 may also be signed with the issuer's private key, and thus the issuer's public key can be used to verify that the issuer of the transaction 102 also issued the request 206.

In some implementations, one or more of the entities 202a-e are controlled by an information provider configured for responding to queries about information stored the blockchain 100. An example of such a query 208 is shown as being communicated from one entity 202c to another entity 202d (e.g., in a scenario where the other entity 202d is controlled by or represents the information provider). For example, the information provider determines that at least some of the information referenced by the query, e.g., information in the erasable portion 106, has been erased from the blockchain 100. Thus, in response to the query 208, the information provider provides none of the information that has been erased from the blockchain. Further, the information provider can provide evidence that the information has been erased from the blockchain, such as the block 204 that previously contained the information that has been erased from the blockchain.

In some examples, the query includes a reference to a particular transaction stored in a particular block. For example, the query may specify an identifier for the transaction and an identifier for the block, such as a transaction number and a block number. The query need not contain any of the information contained in the erasable portion 106.

In some examples, the information provider also carries out requests to erase data from the blockchain, e.g., the request 206. For example, the information provider verifies that the issuer of the request is authorized to request the erasure of the information (e.g., if the issuer of the request was the issuer of the transaction or another kind of issuer authorized to erase information from the blockchain 100).

Example Techniques

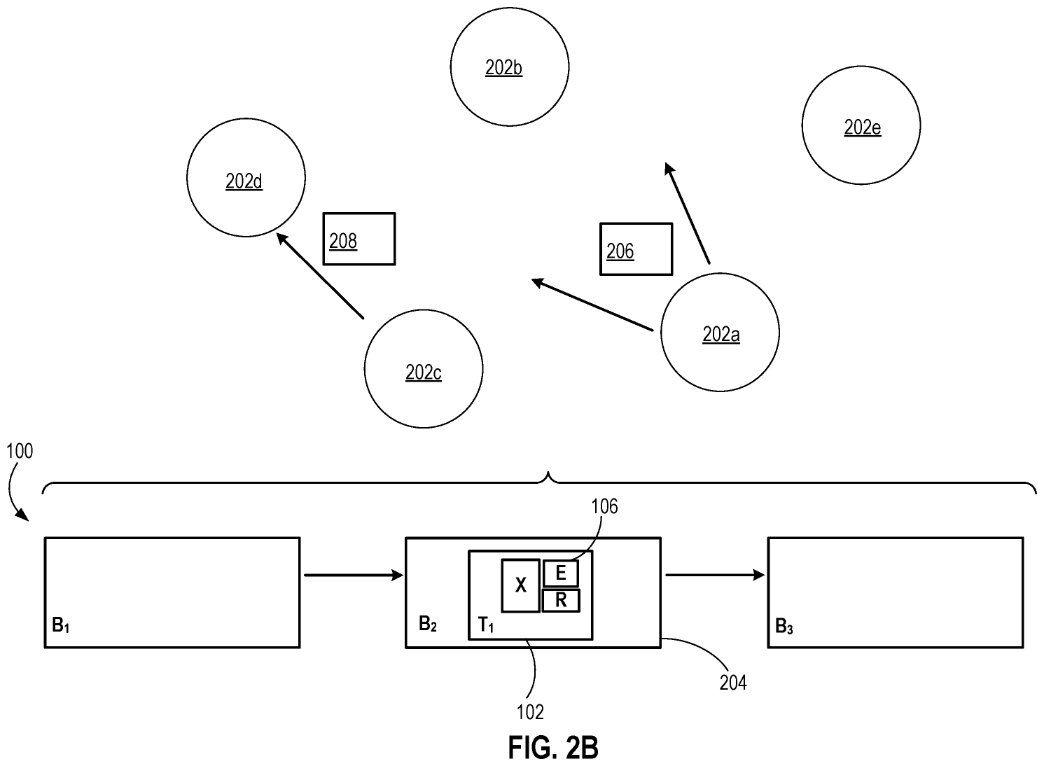

FIG. 3 shows a flowchart of a process 300 for enabling one or more entities of a blockchain system to carry out operations using a blockchain of the blockchain system. An example of the blockchain 100 is shown in FIG. 1 and examples of the entities 202a-e are shown in FIGS. 2A-2B.

At least one of the entities receives 302 an indication to erase an erasable portion of a transaction in a valid block previously added to the blockchain. An example of the erasable portion 106 is shown in FIG. 1. In some examples, the indication to erase the erasable portion of the transaction was issued by the issuer of the transaction. In some implementations, at least one of the entities verifies that the transaction was issued by the issuer of the transaction. For example, at least one of the entities determines that the request was signed by a private key corresponding to a private key associated with (e.g., that signed) the transaction.

At least one of the entities causes 304 the erasable portion of the transaction to be erased while preserving the non-erasable portion of the transaction. An example of the non-erasable portion 104 is shown in FIG. 1.

At least one of the entities guarantees 306 that the block containing the transaction, including the non-erasable portion, is still a valid block of the blockchain. An example of the block 204 is shown in FIGS. 2A-2B. In some examples, this includes retaining a header of the block, wherein the header contains information derived from the erasable portion of the block. An example of the header 116 is shown in FIG. 1. For example, validity of the block is defined by presence of the information in the header. Put another way, if the header remains unchanged, the block remains a valid block of the blockchain even if the erasable information is erased, e.g., because the header contains the information derived from the erasable information.

In some implementations, the header includes a first transaction hash and a second transaction hash, the first transaction hash comprising a hash of a combination of the erasable portion of the transaction and a random value, and the second transaction hash comprising a hash of a combination of the first transaction hash and the non-erasable portion of the transaction. Examples of the hashes are shown in FIG. 1. Further, in some examples, the random value was generated by the issuer of the transaction, and in some examples, the random value is erased when the erasable portion of the transaction is erased.

In some implementations, at least one of the entities determines that the block containing the transaction, including the non-erasable portion, is still a valid block of the blockchain. In some examples, this entails determining a hash of a header of the block, comparing the hash to data in a subsequent block of the blockchain, the data representing a previously determined hash of the header of the block, and determining that that the hash and the data are identical.

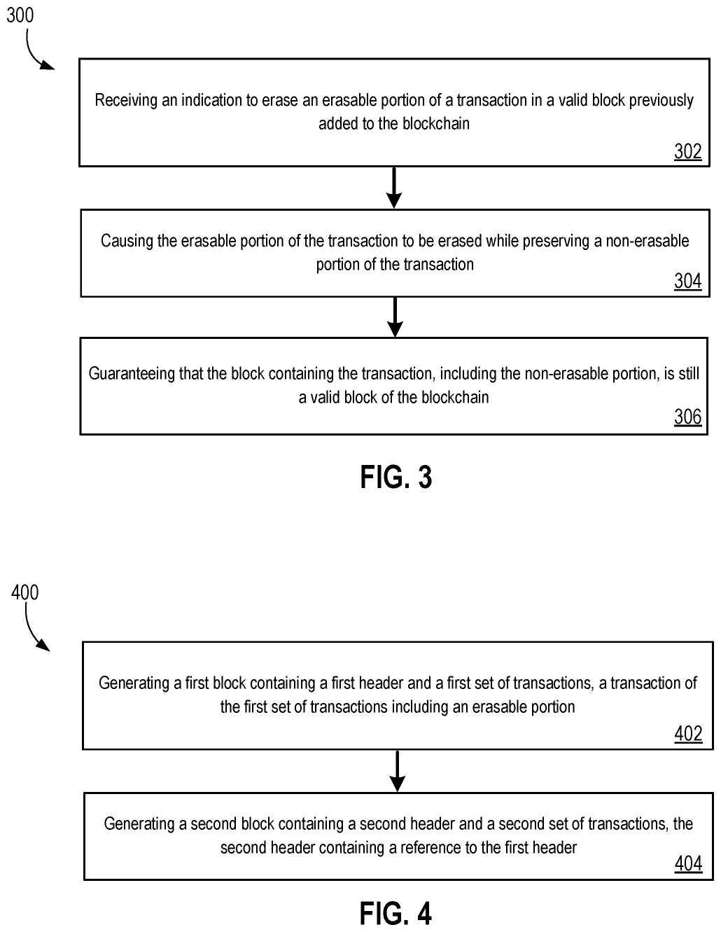

FIG. 4 shows a flowchart of a process 400 for enabling one or more entities of a blockchain system to carry out operations using a blockchain of the blockchain system. An example of the blockchain 100 is shown in FIG. 1 and examples of the entities 202a-e are shown in FIGS. 2A-2B.

At least one of the entities generates 402 a first block containing a first header and a first set of transactions. Examples of the header 116 and the transactions are shown in FIG. 1. A transaction of the first set of transactions includes an erasable portion. Examples of the transaction 102 and the erasable portion 106 are shown in FIG. 1.

In some implementations, the first header contains a reference to the erasable portion of the transaction. In some examples, the first header includes, for each transaction of the set of transactions, a first transaction hash and a second transaction hash. The first transaction hash includes a hash of a combination of an erasable portion of the respective transaction and a random value, and the second transaction hash includes a hash of a combination of the first transaction hash and a non-erasable portion of the transaction. Examples of the hashes are shown in FIG. 1. In some implementations, the random value was generated by the issuer of the transaction. Further, in some examples, at least one of the entities causes the random value to be erased if the erasable portion of the transaction is erased.

At least one of the entities generates 404 a second block containing a second header and a second set of transactions, the second header containing a reference to the first header. The first block remains a valid block of the blockchain if the erasable portion of the transaction of the first set of transaction is erased. For example, the first block remains a valid block of the blockchain because the first header does not change when the erasable portion of the transaction is erased. In some examples, the reference to the first header comprises a hash of the first header.

In some examples, at least one of the entities receives an indication to erase the erasable portion of the transaction of the first set of transactions, and causes the erasable portion of the transaction to be erased. In some examples, the indication to erase the erasable portion of the transaction was issued by the issuer of the transaction. In some implementations, at least one of the entities verifies that the transaction was issued by the issuer of the transaction. For example, at least one of the entities determines that the request was signed by a private key corresponding to a private key associated with (e.g., that signed) the transaction.

Transaction Structure

As noted above, the RTBF techniques described here use two new types transaction fields (e.g., portions): an erasable field and a random field. The first enables one to store information, E, that might be subject to erasure at a later time; and the second a random string, R, that enables the removal of E, if needed at a later time, without disrupting the rest of the information, X, the transaction may contain. The erasable (and respectively, the random) field of a transaction is allowed to be empty, in which case E=0 (respectively, R=0). Accordingly, a transaction T can be written as:

T=(X,E,R).

X continues to remain securely stored in the blockchain, independent of any possible RTBF requests. We sometimes refer to X as the essential information of transaction T.

We call a transaction T=(X, E, R) “RTBF-honest” if all information (e.g., personal information) that might possibly be forgotten solely appears in E, and “RTBF-dishonest” otherwise. Honest users (e.g., non-malicious users) solely issue RTBF-honest transactions.

Block Structure

For a block Bᵢ=(BDᵢ, BHᵢ), BDᵢ continues to include the sequence of the block's transactions,

T₁=(X₁,E₁,R₁), . . . , Tₙ=(Xₙ,Eₙ,Rₙ)

together with the signatures of their issuers. The only change in the transaction format.

BHᵢ includes, for each transaction Tⱼ=(Xⱼ, Eⱼ, Rⱼ) in the block, two hash values:

h′ⱼ=H(Eⱼ,Rⱼ) and hⱼ=H(Xⱼ,hⱼ′).

That is, BHᵢ=(H(BHᵢ₋₁), (h′₁, h₁), . . . , (h′ₙ, hₙ), AD).

Response to RTBF Requests

Assume that an RTBF request is made about an RTBF-honest transaction Tⱼ=(Xⱼ, Eⱼ, Rⱼ) in a prior block Bᵢ. Then, in response to such a request, a consensus participant or an information service provider will substitute (Xⱼ, Eⱼ, Rⱼ) with Xⱼ in her own copy of BDᵢ. That is, she will

Erase Eⱼ and Rⱼ from the block's data BDᵢ;

Continue to store Xⱼ in BDᵢ; and

Continue to keep (h′ⱼ, hⱼ) in the block's header HBᵢ.

In an example, an RTBF request is made about an RTBF-dishonest transaction Tⱼ. Then, in response to such a request, a consensus participant or an information service provider will delete the entire transaction Tⱼ in her own copy of BDᵢ, but continues to keep (h′ⱼ, hⱼ) in the block's header HBᵢ. In either case, upon learning about an RTBF request about Tⱼ, an honest ordinary user, who happens to store block Bᵢ herself, may act in the same way.

Block headers are not affected by RTBF requests. Indeed, new block headers continue to be generated, as the chain grows, but remain unaltered, and are in fact unalterable, once generated.

As long as a transaction Tⱼ=(Xⱼ, Eⱼ, Rⱼ) in a block Bᵢ is not subject to an RTBF request, the unalterability of the entire Tⱼ, including that of Eⱼ and Rⱼ continues to be guaranteed by the blockchain. In fact, given (Xⱼ, Eⱼ, Rⱼ), one can first compute the hash value v=H(Eⱼ, Rⱼ), then the hash value H (Xⱼ, v), and finally verify that they coincide with the two hash values h′ⱼ and hⱼ securely stored in the block's header BHᵢ.

If an RTBF request is made about an RTBF-honest transaction Tⱼ=(Xⱼ, Eⱼ, Rⱼ) in a block Bᵢ, then only the authenticity of the essential information Xⱼ continues to be guaranteed by the blockchain. In fact, as soon as the request is made, Eⱼ and Rⱼ are removed from the block's data BDᵢ, but not Xⱼ. Nor is the pair of hash values (h′ⱼ, hⱼ) removed from the block's header BHᵢ. Thus, to verify the authenticity of Xⱼ, one retrieves the pair (h′ⱼ, hⱼ) from BHᵢ, computes the hash value H (Xⱼ, h′ⱼ), and verifies that the so obtained result indeed coincides with the value hⱼ.

If an RTBF request is made about an RTBF-dishonest transaction Tⱼ=(Xⱼ, Eⱼ, Rⱼ) in a block Bᵢ, then the entire Tⱼ is removed from the block's data BDᵢ. If Tⱼ is a payment, then its removal does not affect other payments in the chain, because a balance-based blockchain (e.g., Algorand) is used. But if Tⱼ were a data transaction, the meaningfulness of subsequent data transactions that rely on Tⱼ's essential information Xⱼ could be compromised. Thus, if the issuer of Tⱼ is not malicious, it is in her very interest to ensure that Tⱼ is an RTBF-honest transaction.

In an RTBF-honest transaction T=(X, E, R), the randomness of the value R guarantees an higher level of compliance with the RTBF. To see this, assume that no random string R were used. That is, assume that all transactions T and block headers BHᵢ were of the form

T=(X,E) and BHᵢ=(H(BHᵢ₋₁), . . . , (v′,v), . . . ,AD),

where v′=H(E) and v=(X, v′). Assume now that E directly identified a famous person: for example, let E=“Oprah”. Then, in response to an RTBF request, the blockchain might very well erase E, but the blockchain still enables any user suspecting that the transaction involves Oprah to prove that this is the case. Indeed, such a user can compute H(Oprah) and check that the so computed value coincides with the securely stored value v′. By contrast, when h′=H(“Oprah”, R), provided that R was randomly selected, once “Oprah” and R have been erased, no one knowing h′ and suspecting that the transaction T refers to Oprah could confirm to herself or prove to others that this is the case.

In an RTBF-dishonest transaction T=(X, E, R), however, R may not be random. Rather, the issuer of T may choose R=0 to enable anyone guessing E to easily confirm the correctness of her guess. This difficulty is avoided by ‘forcing’ T's issuer to choose R in a random manner. For example, adapted verifiable-random-function techniques can be used.

In some implementations, when a transaction T=(X, E, R) is deemed eligible to be stored in a new block i, the block proposer randomly and independently chooses a string R′, which she includes in BDᵢ together with (X, E, R), and the two hash values that she includes in BHᵢ are h′=H(E, R, R′) and h=H(X, h′). In this way, one can still verify the authenticity of the entire T, before an RTBF request is made, or that of just X, after an RTBF request has been made. It is also easy to see that, as long as one of R and R′ is random, when E is erased it is impossible for anyone to correctly guess E and confirm the correctness of the guess. As another example, the block proposer, rather than the T's issuer, can choose R in a forcible and rigorous way.

RTBF-Compliant Information Service Providers

In some examples, information service providers perform two functions:

Enabling new users who wish to join the consensus protocol to obtain the information they need (e.g., in a BBB, the balances at the latest block); and

Enabling users who cannot or do not store the entire blockchain to access the specific pieces of information they need (e.g., a given block or a given transaction).

In some examples, these techniques enable an information service provider to answer each user query with a short and easy-to-verify proof that the answer is indeed correct. Such a proof is solely based on the genesis block, the only block that can be considered unambiguously known.

When queried about a transaction T=(X, E, R), an honest provider returns (X, E, R), with a proper proof, if no RTBF request has been made about T. Else, it returns just X, again with a proper proof, together with proper evidence that T was subject to a legitimate RTBF request.

The proper authorities can easily check whether an information service provider is so RTBF-compliant. For instance, keeping incognito, they can query the provider and check whether it returns information that had to be forgotten. In principle, they could also check whether the provider still stores any information that had to be forgotten, but this would be more complex. An analogous complexity arises for search engines. Assume that a search engine (1) is asked to de-link a page p containing personal information, (2) promises to do so, but (3) actually fails to comply with the request. Then, it is easy for a privacy authority to find out that the search engine is still disclosing p. It is much harder, however, for the authority to check whether the search engine is no longer in possession of page p.

Note that whether an ordinary user continues to keep personal information that had be forgotten is another matter. Such keeping is analogous, in the case of search engines, to that of an individual user who continues to keep a page p that was previously de-linked. It is well established that the RTBF does not require the erasure of all the copies of to-be-forgotten information ever made and stored by anyone.

In general, honest information service providers do not merely abstain from providing information that had to be forgotten. They actually erase any copy of this information they themselves possess, and yet remain capable of continuing to work correctly.

In some examples, an information provider controls one or more entities of a blockchain, e.g., one or more of the entities 202a-e shown in FIGS. 2A-2B.

Ease of Use

These techniques enable a blockchain-based way to communicate to consensus participants and information service providers which personal information should be forgotten, and which has (consensually) been exempted from the RTBF. For instance, to certify that a user u has indefinitely (respectively, until a given time t) waived her RTBF about her personal information E in a transaction T=(X, E, R), society may agree that it suffices for u to co-sign digitally T (respectively, (T, t)).

In some examples, atomic transaction technology guarantees, at layer 1, that the issuer of T and u can independently sign T, without worrying about who signs first, with the guarantee that T will be posted on the blockchain only if it is digitally signed by both parties.

Forward Compatibility

Whatever its consensus protocol, any blockchain can become RTBF compliant simply by switching to the transaction and block structure described above. Should RTBF rules become stricter at a later time, RTBF compliance will be assured, going forward, by including the newly protected personal information in the erasable component of all subsequent transactions.

Partial Adoption

The RTBF approach described here still works when any (or even all) of the consensus participants do not erase the information that should be forgotten: indeed, so long as the transaction and block structures are in place, honest service information providers can still work in an RTBF-compliant way. And dishonest ones can be identified and, e.g., legal action can be taken.

General Commitments

The RTBF approach described here enables separation of, in a transaction T, personal information I from any associated information X, so as to be able to erase E while maintaining the availability and the inalterability of X. Specifically, E is first probabilistically hashed (i.e., hashed together with some randomness that is initially stored), and then X is hashed together with the first hash value.

However, (probabilistic) hashing is a form of commitment. Other commitment schemes may be alternatively used. Such a scheme enables one to (1) ‘pin-down’ a chosen value, while keeping it secret for a while, and then, when deemed appropriate (2) reveal the value in a provable manner, that is, by guaranteeing that the revealed value is indeed the originally chosen one.

Essentially, given a value x, a committer computes another string C(x), the commitment (to x), and another value d, the de-commitment. Traditionally, the committer publicizes C(x) and keeps secret d. The commitment C(x) satisfies two properties. First, it prevents anyone, even the committer herself, to be able to modify the value x at revealing time. (E.g., the binding property.) Second, it prevents anyone else from obtaining any information about x, before it is revealed. (E.g., the secrecy or hiding property.) To reveal the committed value x, the committer also reveals d, so as to enable any one to verify that x is indeed the original string pinned down by the commitment C(x). In the simple implementation of our strategy described earlier in this description, the committed value is the personal information E; the commitment is C(E)=H(E, R); and the decommitment is d=E, R.

Any commitment scheme can be used with the techniques described here. Further, these techniques make non-traditional use of a commitment scheme. In a typical commitment application, the decommitment information is kept secret, because one wants to hide the committed value until it is revealed. In our strategy, instead, both the committed value and the decommitment information are initially made available. However, once the committed value and the decommitment information are both deleted, the secrecy property of the commitment scheme guarantees that E becomes and remains secret.

Example Computer System

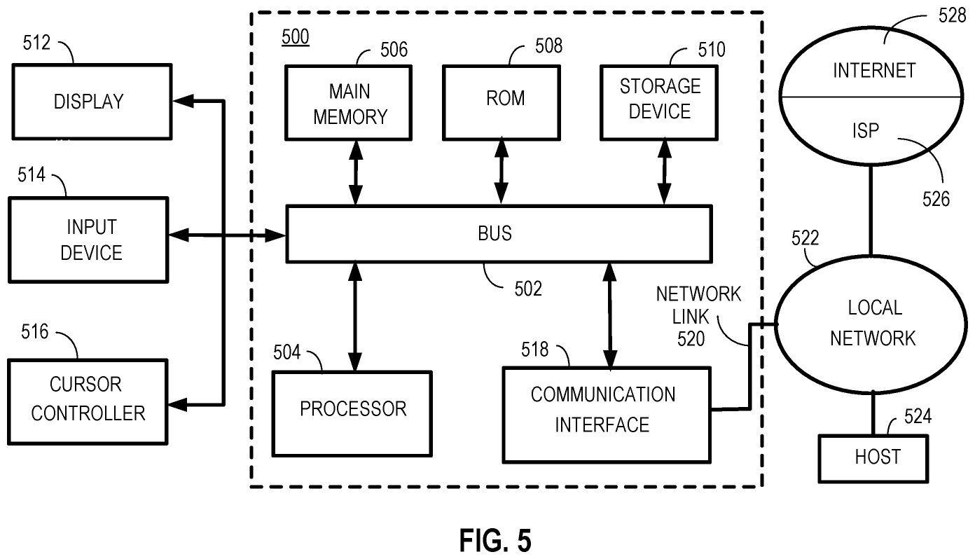

FIG. 5 illustrates an example computer system. In the implementation of FIG. 5, the computer system 500 is a special purpose computing device. The special-purpose computing device is hard-wired to execute blockchain protocols, includes digital electronic devices such as one or more application-specific integrated circuits (ASICs) or field programmable gate arrays (FPGAs) that are persistently programmed to perform the techniques herein, or includes one or more general purpose hardware processors programmed to perform the techniques pursuant to program instructions in firmware, memory, other storage, or a combination. In various implementations, the special-purpose computing devices are desktop computer systems, portable computer systems, handheld devices, network devices or any other device that incorporates both hard-wired or program logic to implement the techniques.

The computer system 500 includes a bus 502 or other communication mechanism for communicating information, and one or more computer hardware processors 504 coupled to the bus 502 for processing information. In some implementations, the hardware processors 504 are general-purpose microprocessors. The computer system 500 also includes a main memory 506, such as a random-access memory (RAM) or other dynamic storage device, coupled to the bus 502 for storing information and instructions to be executed by processors 504. In one implementation, the main memory 506 is used for storing temporary variables or other intermediate information during execution of instructions to be executed by the processors 504. Such instructions, when stored in non-transitory storage media accessible to the processors 504, render the computer system 500 into a special-purpose machine customized to perform the operations specified in the instructions.

In an implementation, the computer system 500 further includes a read only memory (ROM) 508 or other static storage device coupled to the bus 502 for storing static information and instructions for the processors 504. A storage device 512, such as a magnetic disk, optical disk, solid-state drive, or three-dimensional cross point memory is provided and coupled to the bus 502 for storing information and instructions.

In an implementation, the computer system 500 is coupled via the bus 502 to a display 510, such as a liquid crystal display (LCD), plasma display, light emitting diode (LED) display, or an organic light emitting diode (OLED) display for displaying information to a computer user. An input device 514, including alphanumeric and other keys, is coupled to bus 502 for communicating information and command selections to the processors 504. Another type of user input device is a cursor controller 516, such as a mouse, a trackball, a touch-enabled display, or cursor direction keys for communicating direction information and command selections to the processors 504 and for controlling cursor movement on the display 510.

According to one implementation, the techniques herein are performed by the computer system 500 in response to the processors 504 executing one or more sequences of one or more instructions contained in the main memory 506. Such instructions are read into the main memory 506 from another storage medium, such as the storage device 512. Execution of the sequences of instructions contained in the main memory 506 causes the processors 504 to perform the process steps described herein. In alternative implementations, hard-wired circuitry is used in place of or in combination with software instructions.

The term “storage media” as used herein refers to any non-transitory media that store both data or instructions that cause a machine to operate in a specific fashion. Such storage media includes both non-volatile media or volatile media. Non-volatile media includes, such as optical disks, magnetic disks, solid-state drives, or three-dimensional cross point memory, such as the storage device 512. Common forms of storage media include, such as a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge. Storage media is distinct from but is used in conjunction with transmission media. Transmission media participates in transferring information between storage media. Transmission media includes coaxial cables, copper wire and fiber optics, including the wires that include the bus 502.

In an implementation, various forms of media are involved in carrying one or more sequences of one or more instructions to the processors 504 for execution. The instructions are initially carried on a magnetic disk or solid-state drive of a remote computer. The remote computer loads the instructions into its dynamic memory and send the instructions over a telephone line using a modem. A modem local to the computer system 500 receives the data on the telephone line and use an infrared transmitter to convert the data to an infrared signal. An infrared detector receives the data carried in the infrared signal and appropriate circuitry places the data on the bus 502. The bus 502 carries the data to the main memory 506, from which processors 504 retrieves and executes the instructions. The instructions received by the main memory 506 are optionally stored on the storage device 512 either before or after execution by processors 504.

The computer system 500 also includes a communication interface 518 coupled to the bus 502. The communication interface 518 provides a two-way data communication coupling to a network link 520 connected to a local network 522. The communication interface 518 is an integrated service digital network (ISDN) card, cable modem, satellite modem, or a modem to provide a data communication connection to a corresponding type of telephone line. In another implementation, the communication interface 518 is a local area network (LAN) card to provide a data communication connection to a compatible LAN. In some implementations, wireless links are also implemented.

The network link 520 typically provides data communication through one or more networks to other data devices. The network link 520 provides a connection through the local network 522 to a host computer 524 or to a cloud data center or equipment operated by an Internet Service Provider (ISP) 526. The ISP 526 in turn provides data communication services through the world-wide packet data communication network now commonly referred to as the “Internet” 528. The local network 522 and Internet 528 both use electrical, electromagnetic or optical signals that carry digital data streams.

Any or all of the features and functions described above can be combined with each other, except to the extent it may be otherwise stated above or to the extent that any such implementation may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective implementations may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all implementations or that the features represented by such element may not be included in or combined with other elements in some implementations.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

In the foregoing description, implementations have been described with reference to numerous specific details that may vary from implementation to implementation. The description and drawings are, accordingly, to be regarded in an illustrative rather than a restrictive sense. The sole and exclusive indicator of the scope of the implementations, and what is intended by the applicants to be the scope of the implementations, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

What is claimed is:

1. A method of enabling one or more entities of a blockchain system to carry out operations using a blockchain of the blockchain system, the operations comprising:
receiving an indication to erase an erasable portion of a transaction contained in a valid block previously added to the blockchain;
causing the erasable portion of the transaction to be erased while preserving a non-erasable portion of the transaction; and
guaranteeing that the block containing the transaction, including the non-erasable portion, is still a valid block of the blockchain.

2. The method of claim 1 wherein guaranteeing that the block containing the transaction, including the non-erasable portion, is still a valid block of the blockchain comprises:
retaining a header of the block, wherein the header contains information derived from the erasable portion of the block.

3. The method of claim 2 wherein validity of the block is defined by presence of the information in the header.

4. The method of claim 2 wherein the header of the block includes:
a first transaction hash and a second transaction hash,
the first transaction hash comprising a hash of a combination of the erasable portion of the transaction and a random value, and
the second transaction hash comprising a hash of a combination of the first transaction hash and the non-erasable portion of the transaction.

5. The method of claim 4 wherein the random value was generated by an issuer of the transaction.

6. The method of claim 4 comprising causing the random value to be erased when the erasable portion of the transaction is erased.

7. The method of claim 1 wherein the indication to erase the erasable portion of the transaction was issued by an issuer of the transaction.

8. The method of claim 1 comprising determining that the block containing the transaction, including the non-erasable portion, is still a valid block of the blockchain.

9. The method of claim 8 wherein determining that the block containing the transaction, including the non-erasable portion, is still a valid block of the blockchain comprises:
determining a hash of a header of the block;
comparing the hash to data in a subsequent block of the blockchain, the data representing a previously determined hash of the header of the block; and
determining that that the hash and the data are identical.

10. A method of enabling one or more entities of a blockchain system to carry out operations using a blockchain of the blockchain system, the operations comprising:
generating a first block containing a first header and a first set of transactions, a transaction of the first set of transactions including an erasable portion; and
generating a second block containing a second header and a second set of transactions, the second header containing a reference to the first header;
whereby the first block remains a valid block of the blockchain if the erasable portion of the transaction of the first set of transaction is erased.

11. The method of claim 10 comprising:
receiving an indication to erase the erasable portion of the transaction of the first set of transactions; and
causing the erasable portion of the transaction to be erased.

12. The method of claim 10 wherein the first header includes:
for each transaction of the set of transactions, a first transaction hash and a second transaction hash,
the first transaction hash comprising a hash of a combination of an erasable portion of the respective transaction and a random value, and
the second transaction hash comprising a hash of a combination of the first transaction hash and a non-erasable portion of the transaction.

13. The method of claim 12 wherein the random value was generated by an issuer of the transaction.

14. The method of claim 12 comprising causing the random value to be erased if the erasable portion of the transaction is erased.

15. The method of claim 10 wherein the reference to the first header comprises a hash of the first header.

16. The method of claim 10 wherein the first header contains a reference to the erasable portion of the transaction.

17. The method of claim 10 wherein the first block remains a valid block of the blockchain because the first header does not change when the erasable portion of the transaction is erased.

18. The method of claim 10 wherein the indication to erase the erasable portion of the transaction was issued by an issuer of the transaction.

19. A method of enabling one or more entities of a blockchain system to carry out operations using a blockchain of the blockchain system, the operations comprising:
generating a first block containing a first header and a set of transactions, the first header containing a hash of a previous block's header, and
for each transaction of the set of transactions, a first transaction hash and a second transaction hash,
the first transaction hash comprising a hash of a combination of an erasable portion of the respective transaction and a random value, and
the second transaction hash comprising a hash of a combination of the first transaction hash and a non-erasable portion of the transaction;
receiving an indication to erase an erasable portion of a transaction in a valid block previously added to the blockchain;
causing the erasable portion of the transaction to be erased while preserving the non-erasable portion of the transaction; and
guaranteeing that the block containing the transaction, including the non-erasable portion, is still a valid block of the blockchain.

20. A system comprising:
an information provider configured for:
responding to queries about information stored in a blockchain of a blockchain system; and
carrying out requests to erase data from a blockchain of the blockchain system while maintaining validity of the blockchain.

21. The system of claim 20 wherein carrying out a request to erase data from a blockchain of the blockchain system while maintaining validity of the blockchain comprises:
receiving an indication to erase an erasable portion of a transaction in a valid block previously added to the blockchain;
causing the erasable portion of the transaction to be erased while preserving a non-erasable portion of the transaction; and
guaranteeing that the block containing the transaction, including the non-erasable portion, is still a valid block of the blockchain.

22. The system of claim 20 wherein responding to a query about information stored in a blockchain of the blockchain system comprises:
determining that at least some of the information referenced by the query has been erased from the blockchain; and
in response to the query, providing none of the information that has been erased from the blockchain.

23. The system of claim 20 wherein responding to the query about information stored in a blockchain of the blockchain system comprises:
in response to the query, providing evidence that the information has been erased from the blockchain.

24. The system of claim 23 wherein the evidence comprises a block of the blockchain that previously contained the information that has been erased from the blockchain.

25. The system of claim 20 wherein the query about information stored in a blockchain of the blockchain system comprises a reference to a particular transaction stored in a particular block of the blockchain.
